(19) United States
(12) Patent Application Publication
(10) Pub. No.: US 2009/0141495 A1
(43) Pub. Date: Jun. 4, 2009

(54) ELECTRONIC DEVICE

(75) Inventor: Tzu-Wei Lin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/253,229

(22) Filed: Oct. 16, 2008

(30) Foreign Application Priority Data
Nov. 29, 2007 (TW) 96145422

(51) Int. Cl. F21V 33/00

(52) U.S. Cl. 362/253

(57) ABSTRACT

An electronic device including a body having a disposing space, a connecting module, and a lighting module is provided. One end of the connecting module is pivoted to the body, and the other end is pivoted to the lighting module. The connecting module and the lighting module are suitable to be received in the disposing space.

### CROSS-REFERENCE TO RELATED APPLICATION

This application claims the priority benefit of Taiwan application serial no. 96145422, filed on Nov. 29, 2007. The entirety of the above-mentioned patent application is hereby incorporated by reference herein and made a part of specification.

### BACKGROUND OF THE INVENTION

1. Field of the Invention

The present invention generally relates to an electronic device, in particular, to an electronic device having a lighting module.

2. Description of Related Art

In daily life, electronic devices such as a modem, hub and notebook are often placed on a desk or office table. Besides, an illuminating device such as a reading lamp is usually placed on the desk or office table to enhance the illumination on the desk or office table. However, too many electronic devices on a desk or office table may limit the space for the user to work.

Further, if an electronic device such as a notebook is used in a working environment without a reading lamp or any other illuminating device, the dim environment easily causes a failing eyesight of the user.

### SUMMARY OF THE INVENTION

Accordingly, the present invention is directed to an electronic device having a lighting module, such that a user can utilize a working space more effectively and work better in an environment with inadequate light.

An electronic device including a body having a disposing space, a connecting module, and a lighting module is provided. One end of the connecting module is pivoted to the body, and the other end is pivoted to the lighting module. The connecting module and the lighting module are suitable to be received in the disposing space.

In an embodiment of the present invention, the connecting module includes a plurality of pivoting members and at least one connecting rod. The pivoting members are respectively disposed between the body and the connecting rod as well as between the connecting rod and the lighting module.

In an embodiment of the present invention, the pivoting members are universal joints (capable of rotating by 360°), and the connecting rod and the lighting module are suitable to move or rotate with the pivoting members as fulcrums.

In an embodiment of the present invention, the connecting module is a combination of a telescopic connecting rod set and a plurality of pivoting members, and the telescopic connecting rod set includes at least two connecting rods.

In an embodiment of the present invention, the connecting module includes a flexible connecting member.

In an embodiment of the present invention, the lighting module includes a lamp shade and a light source, the lamp shade is pivoted to the connecting module, and the light source is arranged in the lamp shade.

In an embodiment of the present invention, the light source is an incandescent lamp, a light-emitting diode (LED), or any other suitable light source.

According to the present invention, a lighting module is integrated into the body of the electronic device, such that more space can be provided in a working environment on a desk or office table, for the user. Further, as the electronic device of the present invention, a notebook has a lighting module, when the user works in an environment with inadequate light, the lighting module can generate enough light for the user to operate the notebook or any other electronic device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a three-dimensional view of an electronic device according to an embodiment of the present invention.

FIG. 1B is a schematic view showing that a lighting module and a connecting module of FIG. 1A are received in a body.

FIG. 2 is a three-dimensional view of an electronic device according to another embodiment of the present invention.

FIG. 3 is a three-dimensional view of an electronic device according to still another embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

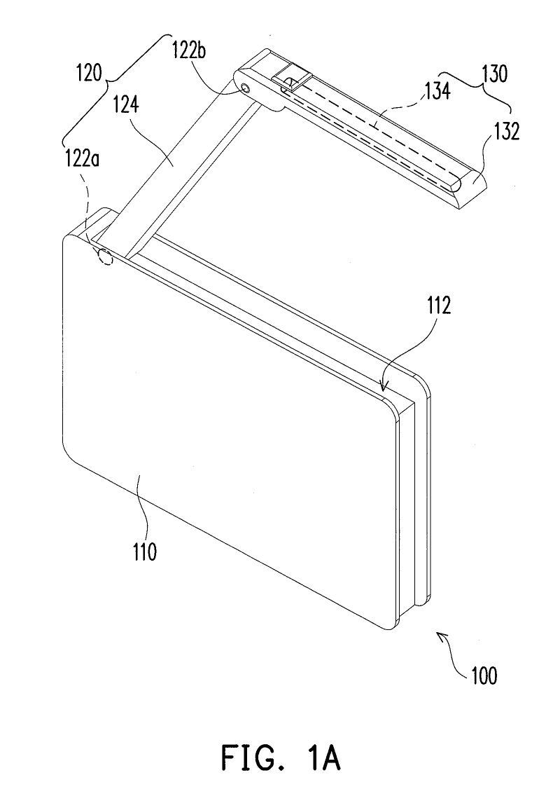

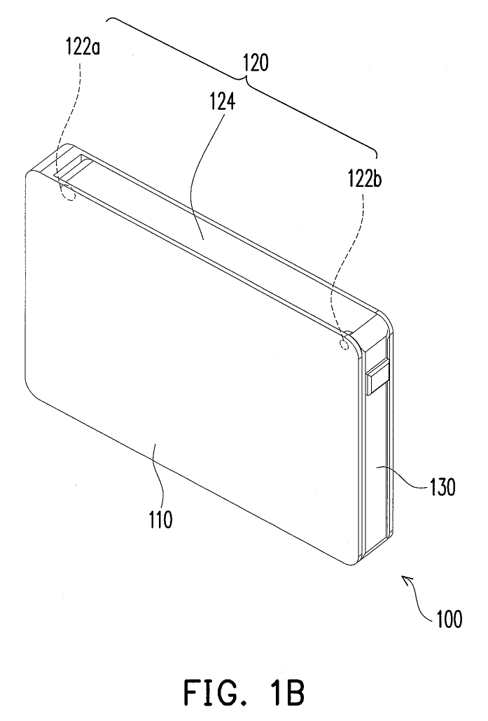

FIG. 1A is a three-dimensional view of an electronic device according to an embodiment of the present invention. FIG. 1B is a schematic view showing that a lighting module and a connecting module of FIG. 1A are received in a body. Referring to FIGS. 1A and 1B, the electronic device 100 of this embodiment is an electronic device, such as a modem, a hub, or a notebook suitable to be placed on a desk or office table. The electronic device 100 mainly includes a body 110, a connecting module 120, and a lighting module 130. In this embodiment, the body 110 has a disposing space 112 suitable for receiving the connecting module 120 and the lighting module 130. The lighting module 130 can be accommodated together with the connecting module 120 in the disposing space 112 of the body 110 when the lighting module 130 does not work.

One end of the connecting module 120 is pivoted to the body, and the other end is pivoted to the lighting module 130. In particular, the connecting module 120 of this embodiment includes a plurality of pivoting members 122a, 122b and at least one connecting rod 124 (one connecting rod 124 is shown as an example in FIG. 1A). The lighting module 130 is constituted by a lamp shade 132 and a light source 134 arranged in the lamp shade 132 (the light source 134 is, for example, an incandescent lamp, an LED, or any other suitable light source).

One end of the connecting rod 124 is pivoted to the body 110 via one pivoting member 122a, and the other end is pivoted to the lamp shade 132 via the other pivoting member 122b. In this embodiment, the pivoting members 122a, 122b are universal joints. Thereby, the connecting rod 124 is suitable to rotate with the pivoting member 122a as a fulcrum, and the lighting module 130 can also rotate with the pivoting member 122b as a fulcrum. That is, after rotating out of the body 110, the lighting module 130 can be adjusted to a proper position through the pivot connection with the connecting rod 124 as well as the pivot connection between the body 110 and the connecting rod 124 to provide enough light to the working environment.

It should be noted that, in this embodiment, the lighting module 130 is integrated into the electronic device 100 that is often placed on a desk or office table, so it is unnecessary to additionally put an illuminating device such as a reading lamp on the desk or office table. As such, more space is provided for the user in the working environment on the desk or office table. Further, when the electronic device 100, such as a notebook, is to be used in a working environment without a reading lamp or any other illuminating device, it is easy to rotate the lighting module out of the body of the notebook to provide adequate light for the user. Therefore, the eyesight of the user is well protected.

On the contrary, if the lighting module 130 is not required to improve the illumination of the environment, it is easy to rotate the connecting module 120 and the lighting module 130 into the disposing space 112.

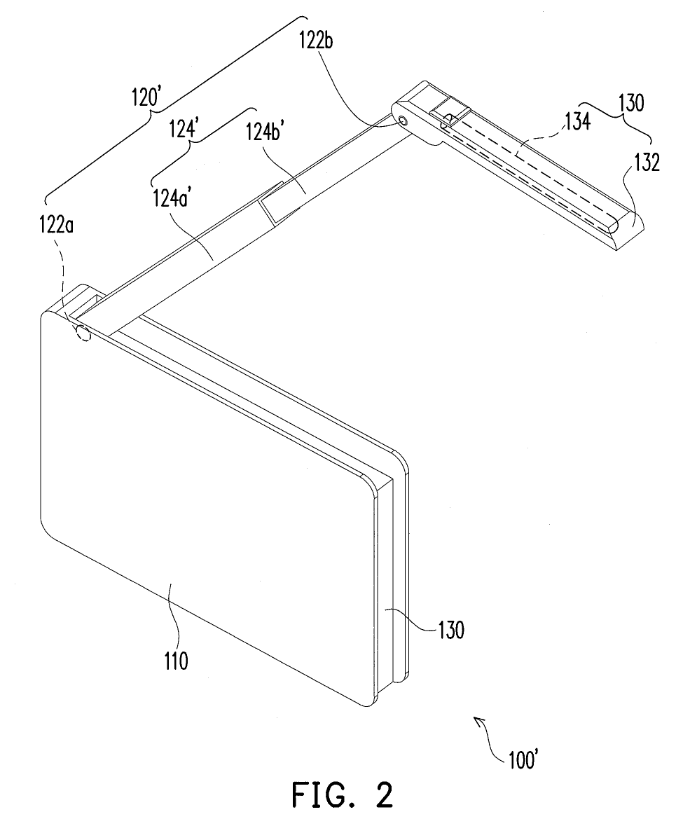

FIG. 2 is a three-dimensional view of an electronic device according to another embodiment of the present invention. Referring to FIG. 2, the electronic device 100′ of this embodiment is similar to the electronic device 100 of the above embodiment. However, the main difference between the two embodiments lies in that, the connecting module 120′ in the electronic device 100′ of this embodiment is a combination of a telescopic connecting rod set 124′ and a plurality of pivoting members 122a, 122b, and the telescopic connecting rod set 124′ is formed by at least two connecting rods 124a′, 124b′. Therefore, when the electronic device 100′ is placed at a position far from the working area of the desk or office table, the connecting rod 124b′ can be movably taken out of the connecting rod 124a′, so as to extend the overall length of the connecting module 120′. In this manner, the lighting module 130 pivoted to the connecting module 120′ can be adjusted to a position above the working area, thus achieving an optimal illumination effect. Certainly, the connecting rod 124b′ can also be adjusted to a position in the connecting rod 124a′, such that the connecting module 120′ can be received conveniently.

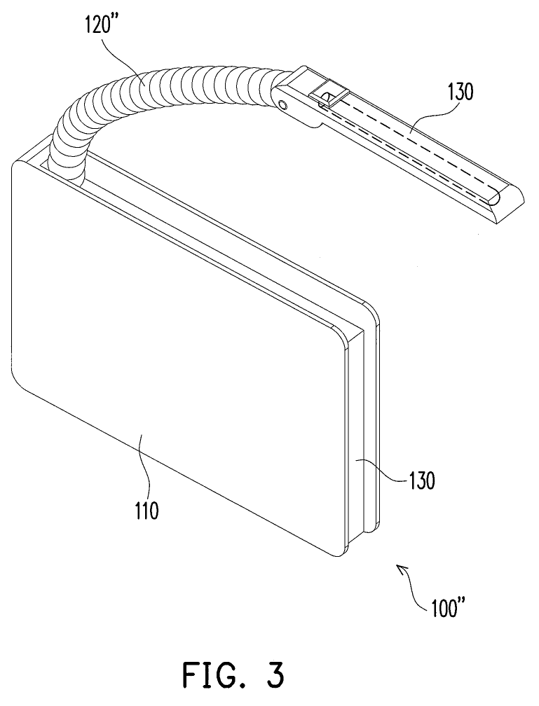

FIG. 3 is a three-dimensional view of an electronic device according to still another embodiment of the present invention. Referring to FIG. 3, the electronic device 100″ of this embodiment is similar to the electronic device 100 of the above embodiment. However, the main difference between the two embodiments lies in that, the connecting module 120″ in the electronic device 100″ of this embodiment is a flexible connecting member, and the user can easily adjust the bending direction of the flexible connecting member so as to adjust the lighting module 130 to the working area with inadequate light.

Of course, in the connecting modules provided by other embodiments, the universal joints, the telescopic connecting rod set, and other appropriate connecting members can be used at the same time, or a rotating shaft can be disposed between the connecting rod 124a′ and the connecting rod 124b′. Further, the connecting module may be foldable, such that the connecting rods 124a′, 124b′ and the lighting module 130 are folded together into a single rod and accommodated in the disposing space 112. These modifications to the present invention are not limited herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a body having a disposing space;
a connecting module, which one end pivoted to the body; and
a lighting module pivoted to the other end of the connecting module,
wherein the connecting module and the lighting module are suitable to be received in the disposing space.

2. The electronic device according to claim 1, wherein the connecting module comprises a plurality of pivoting members and at least a connecting rod, the pivoting members are respectively disposed between the body and the connecting rod as well as between the connecting rod and the lighting module.

3. The electronic device according to claim 2, wherein one of the pivoting members is a universal joint, and the connecting rod and the lighting module are suitable to move with the pivoting member as a fulcrum.

4. The electronic device according to claim 1, wherein the connecting module is a combination of a telescopic connecting rod set and a plurality of pivoting members, and the telescopic connecting rod set comprises at least two connecting rods.

5. The electronic device according to claim 1, wherein the connecting module comprises a flexible connecting member.

6. The electronic device according to claim 1, wherein the lighting module comprises a lamp shade and a light source, the lamp shade is pivoted to the connecting module, and the light source is arranged in the lamp shade.

7. The electronic device according to claim 6, wherein the light source is an incandescent lamp.

8. The electronic device according to claim 6, wherein the light source is a light-emitting diode (LED).
